(19) United States
(12) Patent Application Publication
(10) Pub. No.: US 2006/0263074 A1
(43) Pub. Date: Nov. 23, 2006

(54) Spiral carbon fiber filament weaving belt electric heating element

(76) Inventor: Zhiji Xing, Chelmsford, MA (US)

Correspondence Address: Mr. Zhiji Xing;Apt. B33, 189 Littleton Road, Chelmsford, MA, 01824, US

(21) Appl. No.: 11/186,865

(22) Filed: Jul. 22, 2005

(30) Foreign Application Priority Data
May 18, 2005 (CN) 200520020837.9

(51) Int. Cl. H05B 1/00

(52) U.S. Cl. 392/407

(57) ABSTRACT

This utility model publicizes a kind of new electric heating element belonging to far-infrared electric heating field. This new electric heating element is using micro-thin long carbon fibers are centralized and formed into a strand, then more than one carbon fiber strand are weaved into a long carbon fiber belt, further convolved into spiral item 2. Put spiral item 2 and two groups of transitional linking parts item 3, item 4, item 5 and item 6 into and are sealed in a hollow quartz glass pipe item 1, thus this electric heating element is formed. In the hollow part of sealed quartz glass pipe item 1, high-purity inert gas is filled as auxiliary thermal conduction medium. This makes the electric heating element own the following characters: high transformation rate for electricity and heat; rich far-infrared; large heat radiation energy; long service life time, etc. This kind of electric heating element can be widely applied in far-infrared physical therapy device and civil electric heater products.

### THE FIELD OF INVENTION

The utility model—Spiral Carbon Fiber Filament Weaving Belt Heating Element belongs to electric heating technique field, it utilizes the following physical properties of long carbon fiber filament material: when power is supplied, heat radiates and rich far-infrared light is produced. Extended technical field: the Spiral Carbon Fiber Weaving Belt Electric Heating Element can be used as electric heating element in electric heater and far-infrared physical therapy device.

### THE BACKGROUND OF INVENTION

At present, main electric heating elements used in electric heater are electric heating pipe with metallic shell, halogen quartz heating pipe with metal tungsten wire as electric heating body and porcelain-made electric heating pipe with porcelain as medium. Metallic electric heating pipe and porcelain-made electric heating pipe have such shortages as low heat radiation efficiency and little far-infrared radiation volume. For halogen quartz glass heating pipe, though its heat radiation ability is powerful, however, when it is powered and radiates heat, large light energy is produced, this will reduce the heat energy, simultaneously, the far-infrared is not rich.

After Spiral Carbon Fiber Filament Weaving Belt Heating Element is supplied with power, Electric energy is transformed into heat energy, the transformation efficiency is very high, the radiation energy of far-infrared wavelength section occupies above 85% of all radiation energy. Because Spiral Carbon Fiber Filament Weaving Belt is sealed in quartz glass pipe without oxygen molecule, simultaneously, in the pipe, high-purity inert gas with auxiliary heat conduction function is filled in, so to lower the working temperature of heating body, therefore, the service life of Spiral Carbon Fiber Filament Weaving Belt Heating Element can exceed 5,000 hours.

### SUMMARY OF INVENTION

Sealing Spiral Carbon Fiber Filament Weaving Belt item 2 into a hollow column-shape quartz glass pipe item 1, simultaneously, at both ends of Spiral Carbon Fiber Filament Weaving Belt, two groups of transitional electric linking parts(the linking sequence of each group is shown in FIG. 9) are linked in parallel respectively, Spiral Carbon Fiber Filament Weaving Belt item 2, metal connector item 3, metal molybdenum(or tungsten) pole item 4, metal molybdenum slice item 5 and metal molybdenum pole item 6, linking electrodes to the exteriors of both ends of quartz glass pipe item 1, so to constitute Spiral Carbon Fiber Filament Weaving Belt Electric Heating Element, as shown in FIG. 1.

Technical matters that can be solved by the utility model—Spiral Carbon Fiber Filament Weaving Belt Heating Pipe:

1. Increasing the heat energy value produced by unit electric power of electric heating pipe, increasing the transformation efficiency of electricity and heat. The heat energy produced by Spiral Carbon Fiber Filament Weaving Belt Heating Element is higher than common electric heating element by above 30%.

2. Hollow quartz glass pipe is taken as the sealing medium of Spiral Carbon Fiber Filament Weaving Belt Heating element, it realizes high-temperature sealing for Spiral Carbon Fiber Filament Weaving Belt, simultaneously, this makes the transfer efficiency of far-infrared radiation heat reach the highest value.

3. By scientific adjustment on width, thickness and length of Spiral Carbon Fiber Filament Weaving Belt, the frequency of far-infrared light and the strength of heat radiation spectrum produced by the utility model—Spiral Carbon Fiber Filament Weaving Belt Heating Element can be adjusted.

4. Because the Spiral Carbon Fiber Filament Weaving Belt item 2 sealed into hollow quartz glass pipe item 1 lies in the environment without oxygen molecule, this extends the service life of the utility model—Spiral Carbon Fiber Filament Weaving Belt Heating Element.

5. High-purity inert gas is filled into hollow quartz glass pipe item 1, it has excellent heat conduction performances and can conduct and scatter heat energy produced by Spiral Carbon Fiber Filament Weaving Belt in time. On one hand, it increases the heating efficiency of the electric heating pipe, simultaneously, it lowers the working temperature of Spiral Carbon Fiber Filament Weaving Belt, slows the working fatigue speed of Spiral Carbon Fiber Filament Weaving Belt and increases the service life of the electric heating Element.

### BRIEF DESCRIPTION OF DRAWINGS

FIG. 1: Main View with Half Section View of Spiral Carbon Fiber Filament Weaving Belt Electric Heating Element.

FIG. 2: Left Enlarge View of Spiral Carbon Fiber Filament Weaving Belt Electric Heating Element.

FIG. 3: Plan View with Half Section View of Spiral Carbon Fiber Filament Weaving Belt Electric Heating Element.

FIG. 4: N-N′ Section Enlarge View.

FIG. 5: Three-Strand Carbon fiber Weaving Belt.

FIG. 6: M-M′ Section View.

FIG. 7: Single-Strand Carbon Fiber.

FIG. 8: O-O′ Sectional Enlarge View.

FIG. 9: Link of Transitional Linking Parts Group.

FIG. 10: Q-Q′ Sectional View.

FIG. 11: R-R′ Sectional Enlarge View.

FIG. 12: Two Lines Coincide of Center Line Y-Y′ of quartz glass item 1 and Axial Center Line K-K′ of Convolution of Spiral Carbon Fiber Filament Weaving Belt item 2.

FIG. 13: U-shape, Multi-Semicircular and Horseshoe-Alike Sketch Map for E-E′ Section of Quartz Glass Item 1.

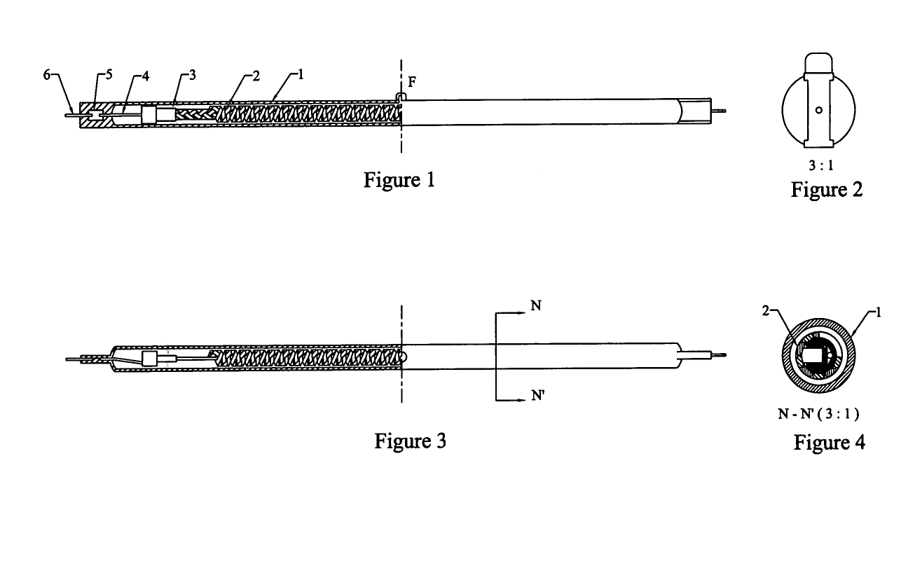

Item 1: Hollow Column-Shape Quartz Glass Pipe.

Item 2: Spiral Carbon Fiber Filament Weaving Belt.

Item 3: Metal Connector.

Item 4: Metal Molybdenum Pole.

Item 5: Metal Molybdenum Thin Slice.

Item 6: Metal Molybdenum Pole

### DETAIL DESCRIPTION

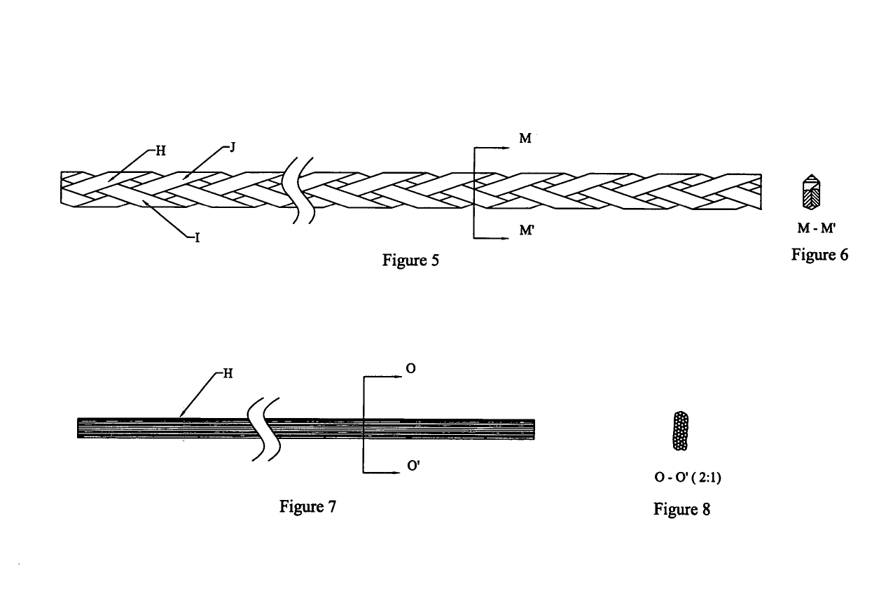

1. According to the design requirements on working voltage and consumption power, assembling long carbon fiber filament with diameter ranges between 3 microns and 20 microns in specified quantity( Quantity of carbon fiber filament is between 500 pieces and 50,000 pieces), so to form a bundle of carbon fiber strand, as shown in FIG. 7 and FIG. 8; then weaving many carbon fiber strands into a long-strip carbon fiber weaving belt by weaving machine. Multi-strand carbon fiber belt weaved with three strands of carbon fiber is shown as in FIG. 5 and FIG. 6. H, I, J represent three carbon fiber strands in three strands of carbon fiber weaving belt; subsequently, with distance larger than 0.1 mm and less than 20 mm as the pitch, with K-K′ as axial center, long-strip carbon fiber weaving belt is convolved into spiral, finally, a spiral carbon fiber weaving belt electric heating body is formed.

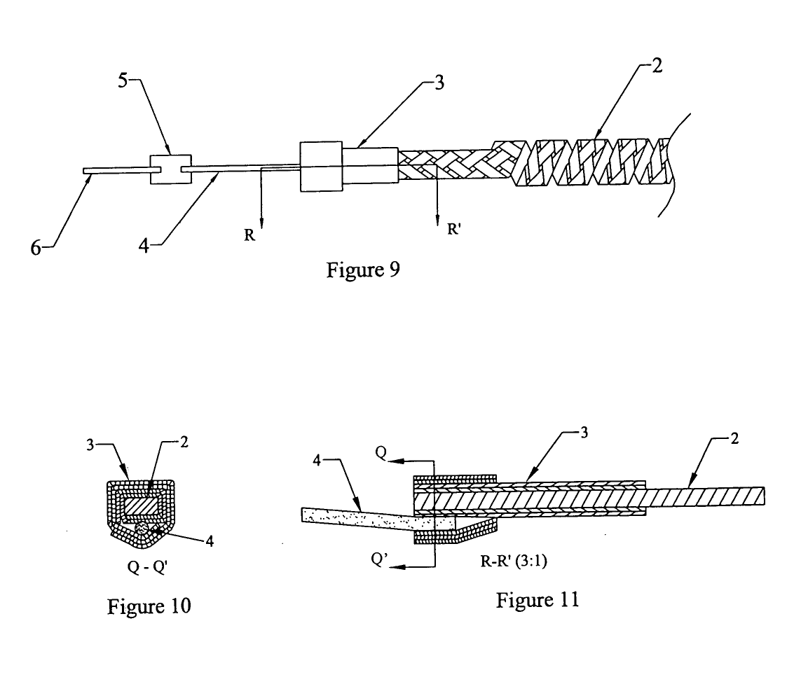

2. At the two tail ends of spiral carbon fiber weaving belt, there is a metal slice with melting point over 800° C. respectively, metal slices are used to pack the two tail ends and constitute metal connector item 3, as showing in FIG. 11 and FIG. 10. Then, a group of transitional electric linking parts are linked on the other tail end of each metal connector item 3 in parallel, metal molybdenum pole item 4, metal molybdenum thin slice item 5 and metal molybdenum pole item 6, as showing in FIG. 9. Connections between item 3 and item 4, item 4 and item 5, item 5 and item 6 are realized by electric spot welding.

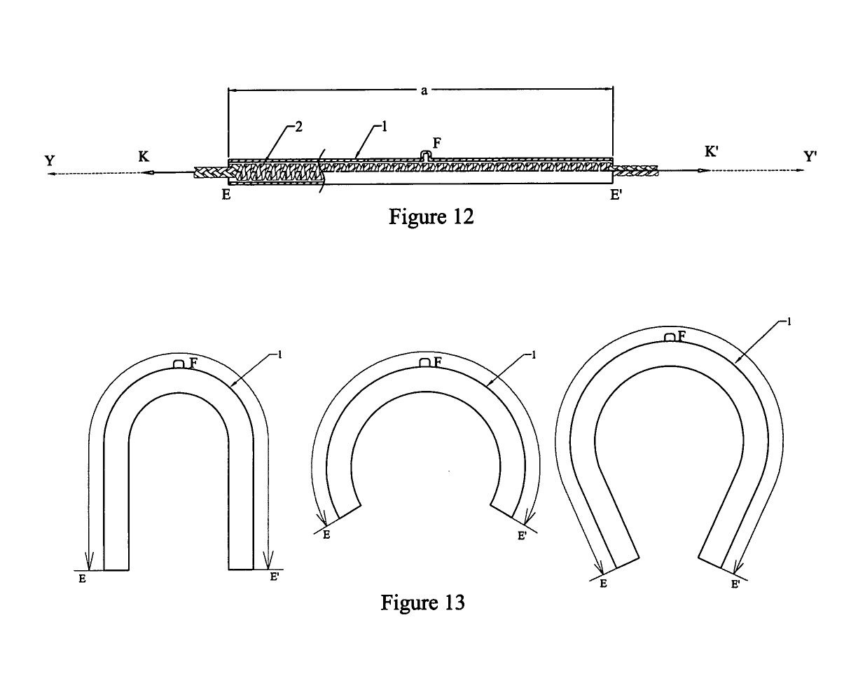

3. Spiral Carbon Fiber Filament Weaving Belt item 2, metal connectors item 3 on two tail ends and two groups transitional electric linking parts (item 4, item 5 and item 6) are inserted into the hollow part of hollow quartz glass pipe together, only a section of two metal molybdenum poles item 6 on both ends exposes outside the hollow quartz glass respectively. The axial center K-K′ of spiral convolution of Spiral Carbon Fiber Filament Weaving Belt item 2 at spiral convolution section (a) is equidirectional and coincidental with the central line Y-Y′ at E-E′ section of quartz glass pipe corresponding to (a) section. E-E′ section can be arbitrary geometrical line shape, however, K-K′ is equidirectional and coincidental with Y-Y′ all along, as shown in FIG. 12 and FIG. 13.

4. In the same time filling protection inert gas into hollow quartz glass pipe through hole F, the two tail ends of hollow quartz glass pipe will be heated with high temperature flame, when quartz glass at tail reaches melting point and starts melting, metallic pressing and sealing mould is used for quick extrusion and pressing, so to realize full closing at the two tail ends of hollow quartz glass pipe respectively. One part of metal molybdenum pole item 6 as the transitional linking part lies outside quartz glass, the other part lies in the center at closing place of quartz glass tail. Metal molybdenum thin slice item 5 as transitional linking part lies in the center at closing place of quartz glass tail completely. One part of metal molybdenum pole item 4 as the transitional linking part lies in the center at closing place of quartz glass tail, the surplus part lies in the hollow place of quartz glass.

5. Air, water in hollow part of quartz glass and oxygen molecule adhered to electric heating body item 2, metal connector item 3 and metal molybdenum pole item 4 as the transitional linking parts in hollow part of quartz glass are pumped out through the air hole F of quartz glass, then inert protection gas is filled in. Finally, air hole F will be closed with quartz glass melted by high-temperature flame at the position F, so to realize the full closing of quartz glass pipe item 1.

I claim:

1. A kind of far-infrared electric heating element constituted by electric heating body which is weaved with multi-strand carbon fiber filament sealed in a hollow quartz glass pipe. The feature is: strip-shape carbon fiber belt weaved with multi-strand long-filament carbon fiber is convolved into spiral shape item 2 and sealed in a hollow quartz glass pipe item 1.

2. According to the right claim 1, wherein carbon fiber belt is weaved with multi-strand carbon fiber, the quantity of carbon fiber strand used in weaving is any amount between 2 strands and 50 strands.

3. According to the right claim 1, wherein the quantity of carbon fiber filament contained in each carbon fiber strand used to weave carbon fiber belt is any amount between 500 pieces to 50,000 pieces, in addition, the diameter of each piece of carbon fiber filament is any amount between 3 microns to 20 microns.

4. According to the right claim 3, wherein each of carbon fiber filament is made from carbonizing the polyacrylonitrile fiber by high temperature process of polyacrylonitrile fiber filament.

5. According to the right claim 1, wherein at the two tail ends of spiral multi-strand carbon fiber weaving belt item 2, there is a metal slice with melting point over 800° C. respectively, metal slices are used to pack the two tail ends and constitute metal connector item 3, the quantity of packing layers is any amount between 1 and 10, include 1 layer and 10 layers.

6. According to the right claim 1, wherein the linking between metal connector item 3 and 4 is completed by spot welding.

7. According to the right claim 1, wherein the axial center line K-K′ of spiral convolution at (a) section of spiral multi-strand carbon fiber weaving belt item 2 sealed in quartz glass pipe item 1 is consistent with the center line Y-Y′ at E-E′ section of quartz glass pipe item 1 in direction, and the quartz glass pipe item 1 at E-E′ section applies any linear geometrical shape.

8. According to the right claim 1, wherein the hollow quartz glass pipe item 1 is transparent.

9. According to the right claim 1, wherein the hollow quartz glass pipe item 1 is frosted, white and opaque.

10. According to the right claim 1, wherein in the hollow part of sealed quartz glass pipe, around the spiral multi-strand carbon fiber weaving belt, there is inert protection gas.
